(19) United States
(12) Patent Application Publication
(10) Pub. No.: US 2010/0095221 A1
(43) Pub. Date: Apr. 15, 2010

(54) METHOD, APPARATUS AND COMPUTER PROGRAM PRODUCT FOR PROVIDING CONFIGURATION OF A MOBILE DEVICE

(76) Inventors: Klaus Franz Doppler, Espoo (FI); Antti Seppo Petteri Paananen, Tupos (FI); Adriana Vasilache, Tampere (FI); Shakeel Tabassam, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/467,059

(22) Filed: May 15, 2009

Related U.S. Application Data
(63) Continuation-in-part of application No. 12/248,462, filed on Oct. 9, 2008.

(51) Int. Cl. G06F 3/01

(52) U.S. Cl. 715/747; 709/220

(57) ABSTRACT

A method for providing mobile device configuration may include a processor and a memory storing executable instructions that in response to execution by the processor cause the apparatus to at least perform at least receiving, remote from a mobile terminal, indications of configuration information defining appearance related features for a display of the mobile terminal, enabling provision of feedback to a user of the mobile terminal regarding the appearance related features, and providing the configuration information to the mobile terminal. A corresponding method and computer program product are also provided.

### CROSS REFERENCE TO RELATED APPLICATIONS

This application is a continuation in part of copending U.S. patent application Ser. No. 12/248,462 filed Oct. 9, 2008, the content of which is incorporated herein in its entirety.

### TECHNOLOGICAL FIELD

Embodiments of the present invention relate generally to device configuration technology and, more particularly, relate to a method, apparatus and computer program product for providing for configuration of a mobile device.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to the provision of services to users of electronic devices. Given the popularity of the Internet, and the vast sources of information that are accessible using the Internet, various Internet services have evolved to provide users with information from a plurality of different sources. In this regard, for example, Internet services have evolved for use with personal computers (PCs) in order to provide such devices with a vast array of service to enable access to information.

With recent developments in the area of hand-held or mobile devices improving the capabilities of such devices, it has been desirable to develop mechanisms for providing mobile devices with improved functionality with respect to delivery of various services such as, for example, Internet services. However, configuration of mobile devices, and particularly configuration of the home screen of such devices, often impacts the user experience to a large degree. Accordingly, users will often go to great lengths to try to configure their home screens according to their needs or desires. Such configuration is typically done on the mobile device itself by, for example, adding shortcuts to different applications or making other appearance related changes. In some instances, configuration of mobile devices may be made using a web service via text messages received from the web service. The user then saves the configuration information received in the text messages to install new applications, define access points, define voice over Internet Protocol (VoIP) settings, etc.

Accordingly, it may be desirable to provide a different mechanism by which to configure a mobile device.

### SUMMARY

A method, apparatus and computer program product are therefore provided to provide users with the ability to provide device configuration settings in a flexible and user friendly manner. In some exemplary embodiments, a user may be enabled to utilize a service platform such as a web service to personalize device home screen settings for a mobile terminal in a manner that allows the user to preview the device settings before implementing them on the mobile terminal. The preview (and selection of settings) may be accomplished either at the mobile terminal or at another device.

In an exemplary embodiment, a method of providing configuration of a mobile device is provided. The method may include receiving, at a processor remote from a mobile terminal, indications of configuration information defining appearance related features for a display of the mobile terminal, enabling, via the processor, provision of feedback to a user of the mobile terminal regarding the appearance related features and providing the configuration information to the mobile terminal.

In another exemplary embodiment, a computer program product for providing configuration of a mobile device is provided. The computer program product includes at least one computer-readable storage medium having computer-executable program code instructions stored therein. The computer-executable program code instructions may include program code instructions for receiving, remote from a mobile terminal, indications of configuration information defining appearance related features for a display of the mobile terminal, enabling provision of feedback to a user of the mobile terminal regarding the appearance related features and providing the configuration information to the mobile terminal.

In another exemplary embodiment, an apparatus for providing configuration of a mobile device is provided. The apparatus may include a processor and a memory storing executable instructions that in response to execution by the processor cause the apparatus to at least perform operations including receiving, remote from a mobile terminal, indications of configuration information defining appearance related features for a display of the mobile terminal, enabling provision of feedback to a user of the mobile terminal regarding the appearance related features and providing the configuration information to the mobile terminal.

Embodiments of the invention may provide a method, apparatus and computer program product for employment, for example, in mobile environments. As a result, for example, mobile device users may enjoy an improved capability for obtaining information via their respective computing devices.

### BRIEF DESCRIPTION OF THE SEVERAL VIEWS OF THE DRAWING(S)

Having thus described some embodiments of the invention in general terms, reference will now be made to the accompanying drawings, which are not necessarily drawn to scale, and wherein:

FIG. 1 illustrates one example of a communication system according to an exemplary embodiment of the present invention;

FIG. 2 illustrates a schematic block diagram of an apparatus for enabling the modification, storage and/or provision of configuration information for display appearance of a mobile device according to an exemplary embodiment of the present invention;

FIG. 3 illustrates an example of a basic initial configuration of a mobile terminal home screen according to an exemplary embodiment of the present invention;

FIG. 4 illustrates an example of a modified configuration of a mobile terminal home screen according to an exemplary embodiment of the present invention;

FIG. 5 shows an exemplary flowchart of operations that may be performed in accordance with user configuration updating according to an exemplary embodiment of the present invention;

FIG. 6 shows an exemplary flowchart of operations that may be performed for updating the configuration according to an exemplary embodiment of the present invention;

FIG. 7 shows an exemplary flowchart of operations that may be performed for returning to an old configuration according to an exemplary embodiment of the present invention; and

FIG. 8 is a flowchart according to an exemplary method for providing mobile device configuration according to an exemplary embodiment of the present invention.

### DETAILED DESCRIPTION OF SOME EMBODIMENTS OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Some embodiments of the present invention may provide a mechanism by which improvements may be experienced in relation to configuring the display appearance of a mobile device. In this regard, for example, some embodiments may provide enablement for a user of a mobile device to modify the appearance of a display (e.g., home screen) of the mobile device via configuration that may include the installation of services and other features in association with a service platform (e.g., a web service). Thus, the service platform may enable the user to define configuration settings for the mobile device, either via the mobile device or via a remote computer or terminal, and the configuration settings defined may be automatically sent to the mobile terminal from the service platform or automatically retrieved by the mobile device when the mobile device connects to the service platform. Accordingly, configurations may be stored at the service platform for later restoration if needed (e.g., after a firmware update).

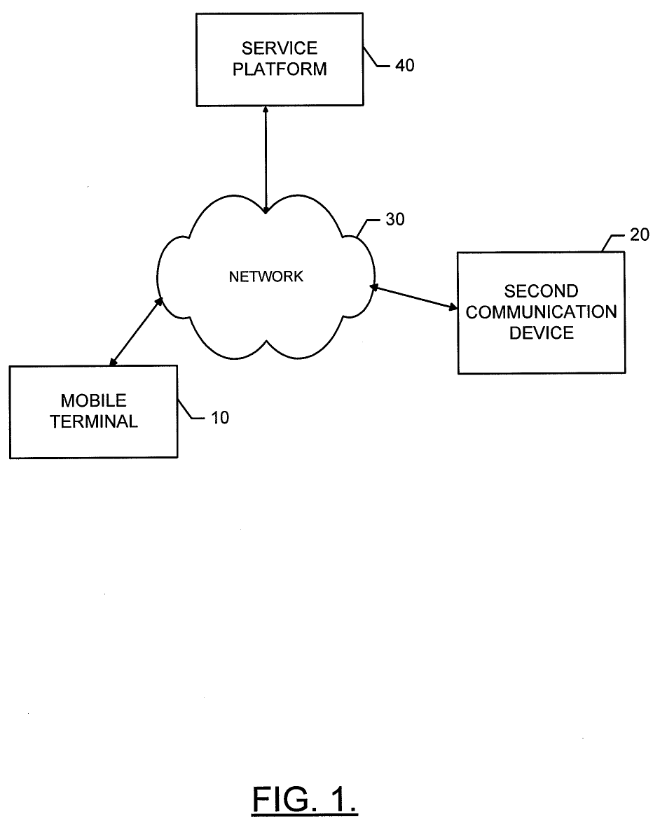

FIG. 1 illustrates a generic system diagram in which a device such as a mobile terminal 10, which may benefit from embodiments of the present invention, is shown in an exemplary communication environment. As shown in FIG. 1, an embodiment of a system in accordance with an example embodiment of the present invention may include a first communication device (e.g., mobile terminal 10) and a second communication device 20 capable of communication with each other via a network 30. In some cases, embodiments of the present invention may further include one or more network devices such as a service platform 40 with which the mobile terminal 10 (and possibly also the second communication device 20) may communicate to provide, request and/or receive information. Furthermore, in some cases, the mobile terminal 10 may be in communication with the second communication device 20 (e.g., a PC) and an application on the second communication device 20 may combine information from the service platform 40 and the mobile terminal 10 in order to enable certain embodiments of the present invention.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing elements (e.g., personal computers, server computers or the like) may be coupled to the mobile terminal 10 and/or the second communication device 20 via the network 30. By directly or indirectly connecting the mobile terminal 10 and/or the second communication device 20 and other devices to the network 30, the mobile terminal 10 and/or the second communication device 20 may be enabled to communicate with the other devices or each other, for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In example embodiments, the first communication device (i.e., the mobile terminal 10) may be a mobile communication device such as, for example, a personal digital assistant (PDA), wireless telephone, mobile computing device, camera, video recorder, audio/video player, positioning device, game device, television device, radio device, or various other like device or combinations thereof. The second communication device 20 may be a mobile or fixed communication device. However, in one example, the second communication device 20 may be a remote computer or terminal such as a personal computer (PC) or laptop computer. As such, the second communication device 20 may be associated with the user of the mobile terminal 10 (e.g., owned or operated by the same user that owns or operates the mobile terminal 10). Alternatively, the second communication device 20 may be a computer, terminal or kiosk associated with a network operator or other party (e.g., a friend of the user) via which the user or an agent of the user may access the service platform 40 to make configuration adjustments as described herein.

In an example embodiment, the service platform 40 may be a device or node such as a server or other processing circuitry. The service platform 40 may have any number of functions or associations with various services. As such, for example, the service platform 40 may be a platform such as a dedicated server, backend server, or server bank associated with a particular information source, function or service (e.g., Ovi by Nokia or myNokia). As such, the service platform 40 may represent one or more of a plurality of different services or information sources. The functionality of the service platform 40 may be provided by hardware and/or software components configured to operate in accordance with known techniques for the provision of information to users of communication devices, except as modified as described herein.

In an exemplary embodiment, the service platform 40 may provide a configuration service to enable either the mobile terminal 10 or the second communication device 20 to utilize the service platform 40 to define configuration information for, among other things, modifying the appearance and/or application and service shortcuts that are available on the home screen of the mobile terminal 10. As such, for example, configuration information defining display appearance related settings of the mobile terminal 10 (e.g., including services or applications accessible directly from the home screen of the mobile terminal 10, background or formatting of the home screen, device settings related to access point configuration, and/or the like) may be alterable and storable at the service platform 40 by either or both of the mobile terminal 10 and the second communication device 20. In either case, the service platform 40 may provide the user with an ability to modify and, in some cases, preview changes to home screen appearance settings prior to implementation and then, enable implementation of the configured settings via connection between the mobile terminal 10 to the service platform 40. In other words, the service platform 40 may provide the functionality associated with modifying and previewing mobile device settings and the functionality may be accessed by either the mobile device or some other device a client/server relationship.

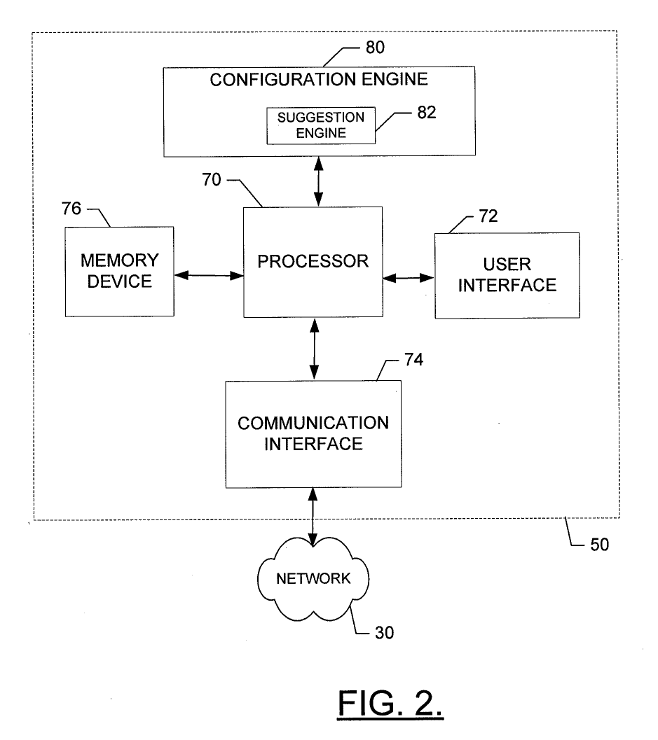

FIG. 2 illustrates a schematic block diagram of an apparatus for enabling the modification, storage and/or provision of configuration information for display appearance of a mobile device such as the mobile terminal 10 according to an exemplary embodiment of the present invention. An exemplary embodiment of the invention will now be described with reference to FIG. 2, in which certain elements of an apparatus 50 for providing an information organization mechanism are displayed. The apparatus 50 of FIG. 2 may be employed, for example, on a communication device (e.g., the mobile terminal 10 and/or the second communication device 20) or a variety of other devices, both mobile and fixed (such as, for example, any of the devices listed above). Alternatively, embodiments may be employed on a combination of devices. Accordingly, some embodiments of the present invention may be embodied wholly at a single device (e.g., the mobile terminal 10) or by devices in a client/server relationship. Furthermore, it should be noted that the devices or elements described below may not be mandatory and thus some may be omitted in certain embodiments.

Referring now to FIG. 2, an apparatus for providing mobile device configuration is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content. In some embodiments, the information stored at the memory device 76 may include configuration information associated with configuring the display of a mobile terminal (e.g., mobile terminal 10) that may be stored in association with an identifier of the mobile terminal or the user of the mobile terminal.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may in some cases otherwise be a general purpose processing element or other functionally configurable circuitry if not for the specific configuration provided by the instructions, to perform the algorithms and/or operations described herein. However, in some cases, the processor 70 may be a processor of a specific device (e.g., a mobile terminal or server) adapted for employing embodiments of the present invention by further configuration of the processor 70 by instructions for performing the algorithms and/or operations described herein.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In fixed environments, the communication interface 74 may alternatively or also support wired communication. As such, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. Accordingly, in some embodiments in which the apparatus 50 is embodied as a server or remote network computing device, the user interface 72 may actually be remotely located at the mobile terminal 10 or the second communication device 20 and instructions or other inputs received therefrom may be received via the communication interface 74.

In an exemplary embodiment, the processor 70 may be embodied as, include or otherwise control a configuration engine 80. The configuration engine 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the configuration engine 80 as described below. Thus, in examples in which software is employed, a device or circuitry (e.g., the processor 70 in one example) executing the software forms the structure associated with such means. In this regard, for example, the configuration engine 80 may be configured to provide, among other things, for the reception of indications of configuration information defining appearance related features for a display of the mobile terminal 10, the provision of feedback to a user of the mobile terminal 10 regarding the appearance related features, and provision of the configuration information to the mobile terminal 10.

Thus, for example, the mobile terminal 10 may have an initial or current home screen display configuration that the user may wish to change. In order to affect the change, rather than making the changes directly to the mobile terminal 10 itself, the user may employ the configuration engine 80 at the service platform 40. Utilization of the service platform 40 may offer advantages in that the mobile terminal 10 may undergo firmware changes and the user may still access the desired display configuration settings to be loaded onto the mobile terminal 10 thereafter without having to repeat previously undertaken configuration steps that could be very involved and/or time consuming to repeat in some cases. Additionally, the service platform 40 may be configured to store multiple different configuration options (e.g., a situationally specific configuration, a context specific configuration option, a past configuration option, a model (e.g., mobile terminal model) specific configuration option and/or the like) for recovery or installation based on priority, user preference, specific user selection, predefined criteria or other criteria. Thus, in some cases, the user could select an option to view configuration settings for a different mobile terminal model so that, for example, the user could evaluate a particular home screen configuration as it might appear on different models the user may be considering purchasing or has already purchased.

In an exemplary embodiment, the configuration engine 80 may be configured to receive indications regarding specific application shortcuts or icons to be added to the home screen. In some cases, the indications may relate to services and/or applications that have been installed on the mobile terminal 10. The indications may include selections regarding wallpaper, format, language, or other home screen appearance options. In some embodiments, the indications may include settings that may be pushed to the mobile terminal 10. The indications of configuration information defining appearance related features for the display of the mobile terminal 10 may therefore be generally related to personalizing or enhancing the utility and/or appearance of the home screen of the mobile terminal 10 to the user's specifications.

The indications may be received either from the mobile terminal 10 itself or from a device other than the mobile terminal 10 such as, for example, the second communication device 20. As such, the user may employ the mobile terminal 10 and/or the second communication device 20 to access the service platform 40 to engage the configuration engine 80 in relation to utilizing services associated with defining configuration information to modify the home screen. In some embodiments, the configuration engine 80 may provide standard configurations to form the basis for a personalized configuration. The standard configurations may include recommended applications and/or services. In some cases, the recommended applications and/or services may be related to a specific theme (e.g., a news theme may have services providing RSS (really simple syndication) feeds, alerts or links to news related information sources, a sports theme may have sport related icons and/or services provided, a social network theme may provide a setup for easy access to posts from friends for a selected social network), or may include recommendations from friends, paying advertisers or other sources.

In this regard, in some cases, the configuration engine 80 may include or otherwise be configured to act as a suggestion engine 82 that may provide the recommended applications. The suggestion engine 82 may be any means such as a device or circuitry operating in accordance with software or otherwise embodied in hardware or a combination of hardware and software thereby configuring the device or circuitry to perform the corresponding functions of the suggestion engine 82 as described herein. In this regard, for example, the suggestion engine 82 may be configured to provide suggestions with regard to specific predefined configurations, or specific configuration options based on the recommended applications and/or services. As such, for example, in a situation in which the service platform is associated with a service such as the Ovi store, applications that can be purchased or otherwise acquired via the Ovi store may be previewed. In particular, a developer of such applications may provide example messages to be displayed on the home screen (multiple messages may be provided if different configurations of the application are possible) when offering the application to the Ovi store. The Ovi store can then use the home screen settings to recommend new applications to the user. The user can then selectively choose from the recommended applications.

The configuration engine 80 may be further configured to enable provision of feedback to the user in one of numerous possible ways. In this regard, for example, the configuration engine 80 may be configured to provide for display of a preview of the home screen of the mobile terminal 10 so the user can make selections of options to thereby provide indications of configuration information to the configuration engine 80 and receive a preview of what the selections will look like or what functionality such selections will add at the display of the mobile terminal 10. In other words, the feedback may take the form of immediately showing the impact made by selecting each respective configuration setting that the user may be enabled to select in a preview pane or window. Thus, rather than actually impacting the home screen itself in response to configuration information changes made in the process of establishing a home screen configuration, the configuration engine 80 may generate a sample home screen display that may be displayed either on the display of the mobile terminal 10 or on a display of the second communication device 20 depending upon which of such devices is being used to make selections of configuration information options. Thus, the feedback may be provided at the mobile terminal 10 or at a device other than the mobile terminal 10. In an exemplary embodiment, the display options provided for selection as configuration information options may be limited or otherwise dependent upon the model number of the mobile terminal 10 or some other indication of the type of device and therefore the capabilities of the mobile terminal 10. Thus, the feedback may be in the form of a request for model number or other device identification information.

In an exemplary embodiment, the configuration engine 80 may be configured to provide the configuration information to the mobile terminal 10 itself when a corresponding selection instruction such provision is made by the user. In this regard, for example, the configuration engine 80 (or some other entity associated with the service platform 40) may be configured to provide an instruction such as by a selectable button or option (e.g., a “transfer to device” button or option) for providing currently selected configuration information to the mobile terminal 10 for configuration of the home screen of the mobile terminal 10 in accordance with the provided configuration information. The instruction may direct establishment of a connection to the mobile terminal 10 to communicate the configuration information to the mobile terminal 10, or may direct provision of the configuration information to the mobile terminal 10 automatically during the next communication session conducted with the mobile terminal 10. Thus, whether the configuration information settings are selected using the mobile terminal 10 or the second communication device 20, the settings may only be possible settings until the instruction for provision of such information to the mobile terminal 10 has been selected. Therefore, selection of the instruction may actually cause the mobile terminal 10 to receive the corresponding configuration information and conduct device configuration for the mobile terminal 10 in accordance therewith.

In some embodiments, rather than providing for delivery of the configuration information to the mobile terminal 10 based on selection of an instruction button or option associated with the service platform 40, the service platform 40 (e.g., via the configuration engine 80) may be configured to provide any newly selected configuration information to the mobile terminal 10 the next time the mobile terminal 10 establishes communication with the service platform 40.

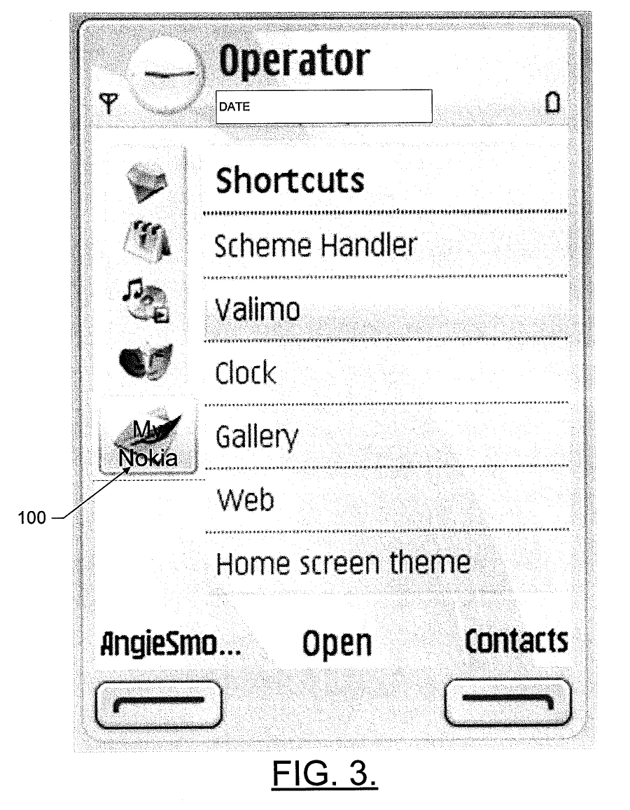

FIG. 3 illustrates an example of a basic initial (or perhaps current) configuration of a mobile terminal home screen. As such, the configuration of FIG. 3 may be an out-of-the-box or default configuration. In some embodiments, the default configuration may include a shortcut to a service capable of enabling personalization of the home screen (e.g., the myNokia icon 100). Thus, by selection of the shortcut, the user may be enabled to relatively quickly and easily configure the home screen in a desirable manner.

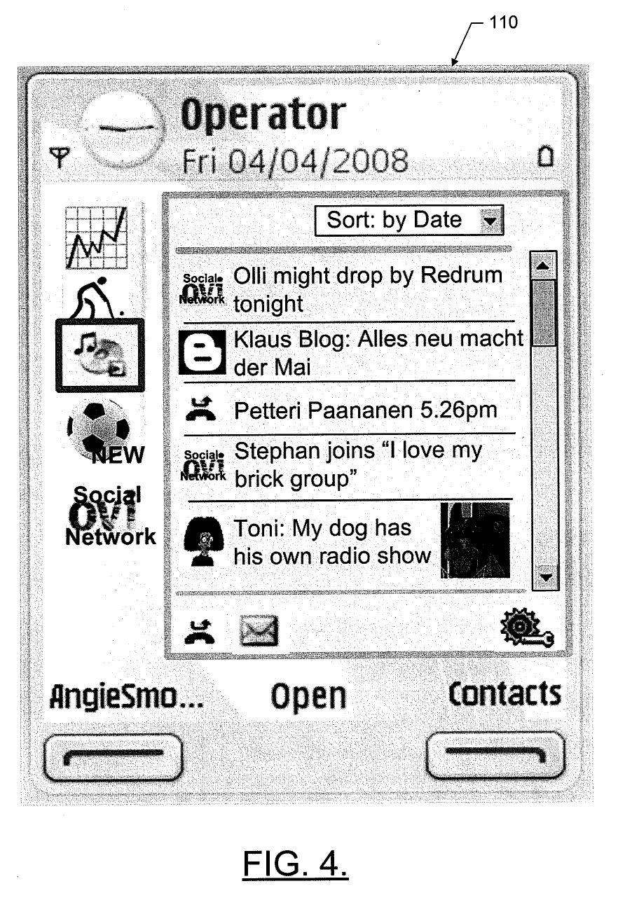

Utilizing a standard configuration, recommended configuration options, or manually selected configuration options used to select individual appearance characteristics, device settings and/or services and applications via the configuration engine 80, the user may personalize the home screen according to the display sample 110 shown in FIG. 4. As such, FIG. 4 illustrates an example of a configuration of a mobile terminal home screen based on user selections of configuration information that may be provided either at the mobile terminal 10 or at another device (e.g., the second communication device 20). In an exemplary embodiment, the view shown in the display sample 110 may appear in a viewing window on the second communication device 20, if such device is used to provide selections of the configuration information used to generate the display sample 110. Then, if selected for transfer to the mobile terminal 10, the display sample 110 may actually represent the home screen of the mobile terminal 10 after the configuration information is loaded at the mobile terminal 10 and implemented.

In the display sample 110 (or home screen if the display sample 110 is selected for adoption by the user) application shortcuts may be provided in a particular region (e.g., on the left side of the display in FIG. 4). Additionally, the shortcuts themselves may include configurable features. For example, the text “NEW” on the sports logo shortcut in FIG. 4 may be indicative of new sports results being available. The user may select configuration options to enable or disable such indications for respective different services. An event log may also be provided in a portion of the display to show internal events (e.g., missed phone calls) and events related to web services (e.g., new blog entries, messages from friends or other individuals or from social networking, short message service, instant messaging, chat or other services). In some cases, the user may be enabled to configure which events (or events associated with which services or individuals) are to be displayed on the event log. The user may also be enabled to configure which operations take place in response to selecting any one of the shortcuts, icons, or entries (e.g., event log entries) from the home screen. For example, the user may define that an RSS reader is to be launched in response to selection of a blog entry, that a preview of a blog entry is to be generated on the home screen, that a social network application is to be launched, that a message reply should be generated, and/or the like. In some embodiments, the home screen may include areas that may be filled with widgets the user wishes to add through configuration of the home screen.

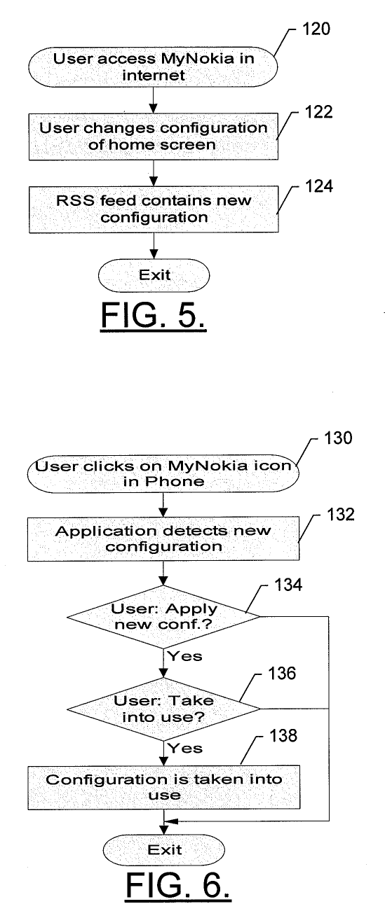

FIG. 5 shows an exemplary flowchart of operations that may be performed in accordance with user configuration updating according to an exemplary embodiment. In this regard, as shown at operation 120, the user may access an application configuration service (e.g., “MyNokia”) via the network 30 (e.g., the Internet) and/or execute a configuration application. At operation 122, the user may change configuration information (e.g., home screen configuration settings). The configuration settings may then be added to the mobile terminal 10 via a feed mechanism (e.g., RSS feed) at operation 124. In some cases, the configuration service may request a model or other identification number of the mobile terminal 10 to offer additional services. Such information may be provided from a user profile or directly by the user. In an alternative mechanism, the user may launch a configuration application, which may then connect to the configuration service to enable the configuration service to access the identification number of the mobile terminal 10 and the current configuration. Current configuration information may otherwise be assumed to be the last configuration loaded.

In some cases, rather than automatically initiating a configuration selected at the service platform 40 the next time the mobile terminal 10 connects to the service platform 40, the user may be enabled to control installation of available configuration information. As such, FIG. 6 shows an exemplary flowchart of operations that may be performed for updating the configuration according to an exemplary embodiment. In this regard, for example as shown at operation 130, the user may select a configuration application in the mobile terminal 10. The application may then detect a new configuration (e.g., via RSS feed) at operation 132. The user may be asked whether the new configuration is to be applied at operation 134. It the user answers “yes”, a preview of the new configuration may be displayed and/or the user may select to take the new configuration into use at operation 136. If the user selects “yes”, the configuration is taken into use at operation 138 and activated.

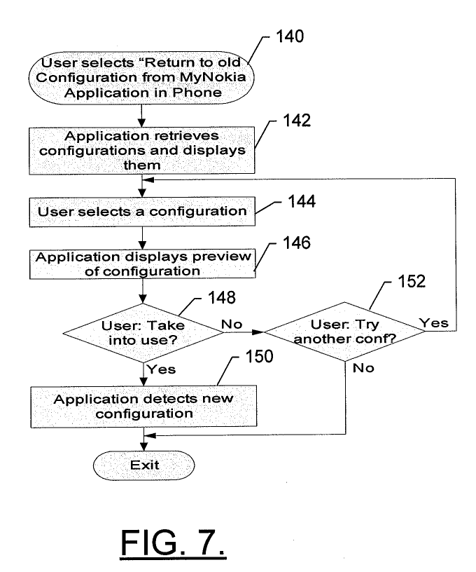

FIG. 7 shows an exemplary flowchart of operations that may be performed for returning to an old configuration according to an exemplary embodiment. At operation 140, the user may select an option for returning to old configuration settings. The configuration application may then retrieve information on old configurations and display them to the user at operation 142. Supported choices (e.g., based on configuration creation date, duration of activity, descriptive name (e.g., chosen by the user during creation or automatically named using some convention), and/or the like) may be previewable. The user may select a configuration at operation 144 and a preview of the selected old configuration may be displayed at operation 146. The user may then be offered an option to take the old configuration into use at operation 148. If the user takes the old configuration into use, the configuration application may detect the old configuration and the old configuration may be added to the mobile terminal 10 via the feed mechanism (e.g., in a fashion similar to that described in relation to FIG. 6 above) at operation 150. If the user does not wish to select the previewed configuration, the user may try to select another configuration at operation 152.

In an exemplary embodiment, each device registered to the configuration service may be assigned a dedicated feed mechanism (e.g., RSS feed such as RSS 1.0, RSS 2.0, Atom or the like) that may include the configuration data of the user or device. Due to the provision of configuration information by the feed mechanism, configuration data may not be limited in size (e.g., to the maximum size of a text message). Configuration data for home or idle screen configuration as well as many other types of configuration information may be provided by this mechanism. Additionally, configurations may be shared between multiple terminals, devices and/or users. In this regard, for example, a user may provide a configuration to a friend by simply forwarding the configuration to an RSS feed address.

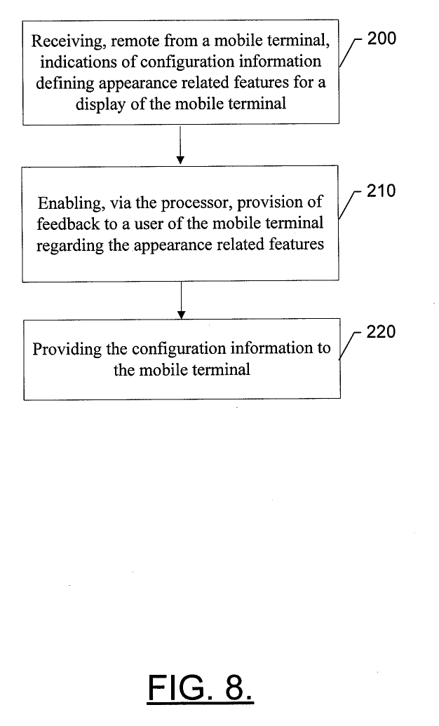

FIG. 8 is a flowchart of a method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device (e.g., memory device 76) and executed by a processor (e.g., processor 70). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). These computer program instructions may also be stored in a computer-readable memory that may direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing an information organization mechanism as illustrated, for example, in FIG. 8 may include receiving, at a processor remote from a mobile terminal, indications of configuration information defining appearance related features for a display of the mobile terminal at operation 200. The method may further include enabling, via the processor, provision of feedback to a user of the mobile terminal regarding the appearance related features at operation 210 and providing the configuration information to the mobile terminal at operation 220.

In some embodiments, certain ones of the operations above may be modified or further amplified as described below. It should be appreciated that each of the modifications or amplifications below may be included with the operations above either alone or in combination with any others among the features described herein. In this regard, for example, receiving indications may include receiving indications of an application shortcut and/or a service feature to be added to a home screen of the mobile terminal. Additionally or alternatively, receiving indications may include receiving indications from the mobile terminal or from a device other than the mobile terminal. In some situations, enabling provision of feedback to the user may include requesting model information descriptive of the mobile terminal from the user. Additionally or alternatively, enabling provision of feedback to the user may include providing for display of a preview of the home screen of the mobile terminal at the mobile terminal or at a device other than the mobile terminal. In an exemplary embodiment, providing the configuration information to the mobile terminal may include providing the configuration information to the mobile terminal in response to an instruction received at a device other than the mobile terminal. In some cases, providing the configuration information to the mobile terminal may include providing the configuration information to the mobile terminal in response to subsequent establishment of communication between the mobile terminal and the processor.

In an exemplary embodiment, an apparatus for performing the method of FIG. 8 above may comprise a processor (e.g., the processor 70) configured to perform some or each of the operations (200-220) described above. The processor may, for example, be configured to perform the operations (200-220) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-210 may comprise, for example, the processor 70, the configuration engine 80, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising a processor and a memory storing executable instructions that in response to execution by the processor cause the apparatus to at least perform the following:
receiving, remote from a mobile terminal, indications of configuration information defining appearance related features for a display of the mobile terminal;
enabling provision of feedback to a user of the mobile terminal regarding the appearance related features; and
providing the configuration information to the mobile terminal.

2. The apparatus of claim 1, wherein the instructions further cause the apparatus to receive indications of an application or service to be added to a home screen of the mobile terminal.

3. The apparatus of claim 1, wherein the instructions further cause the apparatus to receive indications of a device setting to be added to a home screen of the mobile terminal.

4. The apparatus of claim 1, wherein the instructions further cause the apparatus to receive indications from the mobile terminal.

5. The apparatus of claim 1, wherein the instructions further cause the apparatus to receive indications from a device other than the mobile terminal.

6. The apparatus of claim 1, wherein enabling provision of feedback to the user comprises requesting model information descriptive of the mobile terminal from the user.

7. The apparatus of claim 1, wherein the instructions causing the apparatus to perform enabling provision of feedback to the user further cause the apparatus to provide for display of a preview of the home screen of the mobile terminal at the mobile terminal.

8. The apparatus of claim 1, wherein the instructions causing the apparatus to perform enabling provision of feedback to the user further cause the apparatus to provide for display of a preview of the home screen of the mobile terminal at a device other than the mobile terminal.

9. The apparatus of claim 1, wherein the instructions causing the apparatus to provide the configuration information to the mobile terminal further cause the apparatus to provide the configuration information to the mobile terminal in response to an instruction received at a device other than the mobile terminal.

10. The apparatus of claim 1, wherein the instructions causing the apparatus to provide the configuration information to the mobile terminal further cause the apparatus to provide the configuration information to the mobile terminal in response to subsequent establishment of communication between the mobile terminal and the processor.

11. The apparatus of claim 1, wherein the instructions causing the apparatus to receive indications of configuration information further cause the apparatus to receive a recommendation for an application, service feature or device setting from a suggestion engine.

12. The apparatus of claim 1, wherein, in response to receiving indications of a model number of a particular device, providing the feedback further cause the apparatus to provide a preview of display features for a home screen of the particular device.

13. The apparatus of claim 1, wherein the instructions causing the apparatus to provide the configuration information to the mobile terminal further cause the apparatus to provide a predefined response for selection of an item on a home screen of the mobile terminal.

14. The apparatus of claim 1, wherein the instructions causing the apparatus to provide the configuration information to the mobile terminal further cause the apparatus to provide a predefined configuration of an event log.

15. A method comprising:
receiving, remote from a mobile terminal, indications of configuration information defining appearance related features for a display of the mobile terminal;
enabling, via a processor, provision of feedback to a user of the mobile terminal regarding the appearance related features; and
providing the configuration information to the mobile terminal.

16. The method of claim 15, wherein receiving indications comprises receiving indications of an application, service feature or device setting to be added to a home screen of the mobile terminal.

17. The method of claim 15, wherein receiving indications comprises receiving indications from the mobile terminal or a device other than the mobile terminal.

18. A computer program product comprising at least one computer-readable storage medium having computer-executable program code instructions stored therein, the computer-executable program code instruction comprising:
program code instructions for receiving, remote from a mobile terminal, indications of configuration information defining appearance related features for a display of the mobile terminal;
program code instructions for enabling provision of feedback to a user of the mobile terminal regarding the appearance related features; and
program code instructions for providing the configuration information to the mobile terminal.

19. The computer program product of claim 18, wherein program code instructions for enabling provision of feedback to the user include instructions for providing for display of a preview of the home screen of the mobile terminal at the mobile terminal or at a device other than the mobile terminal.

20. The computer program product of claim 18, wherein program code instructions for providing the configuration information to the mobile terminal include instructions for providing the configuration information to the mobile terminal in response to an instruction received at a device other than the mobile terminal or in response to subsequent establishment of communication between the mobile terminal and the processor.
